(19) United States
(12) Patent Application Publication
(10) Pub. No.: US 2007/0183049 A1
(43) Pub. Date: Aug. 9, 2007

(54) Film scanner

(75) Inventor: Michael Cieslinski, Unterhaching (DE)

Correspondence Address: GIFFORD, KRASS, SPRINKLE,ANDERSON & CITKOWSKI, P.C, PO BOX 7021, TROY, MI, 48007-7021, US

(73) Assignee: Arnold & Richter Cine Technik GmbH & co. Betriebs KG, Munich (DE)

(21) Appl. No.: 11/450,646

(22) Filed: Jun. 9, 2006

(30) Foreign Application Priority Data
Jun. 10, 2005 (DE) DE 102005026912.5

(51) Int. Cl. G02B 1/10

(52) U.S. Cl. 359/581

(57) ABSTRACT

The invention relates to a film scanner for the optical scanning of a film in different spectral ranges comprising an optical receiving system, a diaphragm and an optoelectronic light receiver. The diaphragm has a substantially transparent central region and at least one filter region which surrounds the central region and is made as a spectral filter.

### CROSS-REFERENCE TO RELATED APPLICATIONS

This application claims the benefit of German Patent Application No. 10 2005 026 912.5, filed on Jun. 10, 2005. The disclosure of the above application is incorporated herein by reference.

### FIELD OF THE INVENTION

The invention relates to a film scanner for the optical scanning of a film in different spectral ranges comprising an optical receiving system, a diaphragm and an optoelectronic light receiver.

### BACKGROUND OF THE INVENTION

A film scanner of this type serves for the scanning of the image information of an exposed film, in particular of a motion picture film or of a still picture film, for example for the purpose of a digital post-processing. A transmission arrangement is typically provided for this purpose in which the film material to be scanned is illuminated on the one side and in which the optical receiving system, the associated diaphragm and the light receiver are arranged on the other side. Scanning takes place for different spectral ranges, typically for a red, green and blue illumination of the film. It is furthermore known to make an additional scan on the basis of an illumination of the film with infrared light for the identification of possible defects or contamination of the film material. To permit the scanning of the film in the named different spectral ranges, the film is usually illuminated sequentially with the respective light of the different spectral ranges, i.e. the different color images are recorded sequentially.

The optoelectronic light receiver scans the film illuminated in this manner linewise or areally. The optical receiving system arranged between the film and the light receiver and the diaphragm serve for the optical imaging of the film onto the light receiver with a suitable light beam limitation.

A scanning of the film which is as true to the original as possible is made more difficult by, among other things, aberrations of the optical receiving system. In particular color-dependent aberrations can occur, i.e. the light of the different spectral ranges is imaged differently on the light receiver. It is admittedly known in this connection to make the optical receiving system achromatically or apochromatically in order to correct the chromatic aberrations for a plurality of predetermined wavelengths or spectral ranges of the received light. A correction of this type is, however, complex and correspondingly expensive and it is not least not possible completely free of error due to unavoidable production tolerances.

### SUMMARY OF THE INVENTION

It is an object of the invention to provide a film scanner with improved recording or imaging properties for different spectral ranges in order to achieve a coincidence of the scanning records which are as good as possible for different color channels.

This object is satisfied by a film scanner having a diaphragm that has a substantially transparent central region and at least one filter region which surrounds the central region and is made as a spectral filter.

The film scanner therefore has a diaphragm on the receiver side which not only has a transparent region—or at least a substantially transparent region—in a central arrangement, but additionally one or more filter regions which are arranged outside the central region and are each made as a filter active at specific wavelengths.

The imaging properties of the optical receiving system can be modified for at least one spectral range of the received light or for at least one color channel by a diaphragm of this type, whereas the imaging properties for other spectral ranges or color channels of the scanner are not influenced or are influenced in a different manner by means of the diaphragm. The optical receiving system can thereby be optimized in a manner known per se with respect to one or more spectral ranges for a predetermined diaphragm aperture. The optical receiving system can now additionally be optimized for a further spectral range, with it being able to be accepted that this is only possible ideally for one other diaphragm aperture. This other diaphragm aperture is namely realized by the named filter region of the diaphragm specific to wavelengths. A modified diaphragm aperture is thus effectively realized for this further spectral range which also permits optimized imaging properties of the optical receiving system in the respective further spectral range.

A substantially simplified design results with respect to an embodiment in which the diaphragm aperture is varied mechanically for each wavelength (iris). An electromotor control of the diaphragm is also not necessary and wear problems are completely avoided.

In the context of the invention, “light” or “received light” is not only to be understood as visible light (wavelength approx. 400 nm to approx. 780 nm, but also as infrared light (wavelength higher than approx. 780 nm) or ultraviolet light (wavelength lower than approx. 400 nm).

In accordance with a preferred embodiment, the named filter region of the diaphragm has a different transmission capability in the visible spectral range, on the one hand, and in the infrared spectral range, on the other hand. In other words, the filter properties of the named filter region are different in the visible range and in the infrared range. The diaphragm is thus particularly suitable for conventional optical receiving systems which are used in already known film scanners and are only optimized for color channels lying in the visible range. The in contrast reduced imaging properties in the infrared range can thus be improved in that a stronger beam limitation takes place for received infrared light than for received visible light. A higher degree of transmission is therefore in particular provided for the filter region of the diaphragm in the visible range than in the infrared range.

It is furthermore preferred for the filter region of the diaphragm in the visible spectral range to be substantially transparent and to be substantially impermeable to light in the infrared spectral range, i.e. ultimately a diaphragm with a smaller aperture should be realized by means of the filter region of the diaphragm for the infrared channel of the scanner than for the visible color channels. The filter region therefore acts as an infrared blocking filter. Alternatively, however, it is also possible for the filter region to be only partly transparent in the infrared spectral range so that a graduated beam limitation takes place for infrared light.

In accordance with a preferred embodiment, the filter region surrounds the central region of the diaphragm in ring shape. The filter region and the central region are in particular made rotationally symmetrically together. The filter region and the central region are preferably provided in a fixed arrangement relative to one another.

A particularly simple manufacture of the diaphragm is possible when the filter region and the central region are formed by a common plate—made for example of glass or plastic—with the filter region being formed, for example, by a coating of the plate with the named spectral filter.

The diaphragm can furthermore also have a marginal region which surrounds the central region and the filter region and which is impermeable to light independently of the wavelength. This marginal region can also be formed by a corresponding coating of the aforesaid plate or the marginal region is formed by a mount for the central region and the filter region, with this mount being made, for example, of blackened metal.

The invention also relates to a diaphragm comprising a substantially transparent central region and at least one filter region which surrounds the central region and is made as a spectral filter. Corresponding further developments are possible for this diaphragm, as explained in connection with the diaphragm of the film scanner in accordance with the invention. A particular advantage of a diaphragm of this type consists of the fact that a beam limitation specific to wavelength is effected. Color-specific aberrations in optical systems can thereby be corrected better since the light beam limitation is only carried out for one or more selected spectral ranges, with simultaneously a mechanically variable light beam limitation being avoided.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will be explained only by way of example in the following with reference to the drawings.

FIG. 1 shows the schematic design of a film scanner;

FIG. 2 shows a front view of a diaphragm.

### DETAILED DESCRIPTION OF THE PREFERRED EMBODIMENTS

The following description of the preferred embodiment is merely exemplary in nature and is in no way intended to limit the invention, its application, or uses.

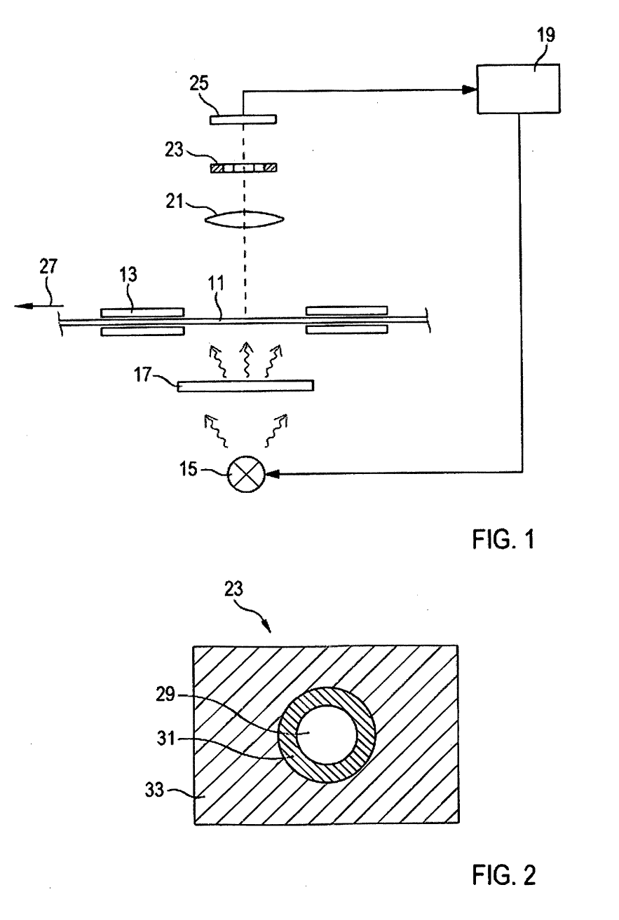

FIG. 1 illustrates the design of a film scanner for the optical scanning of an exposed motion picture film 11, which is guided in a film track 13. The motion picture film 11 or a picture section thereof is illuminated selectively by red, blue, green or infrared light by means of a light source 15 and of a downstream diffuser 17. For example, the light source 15 can be made as a white light source with an associated color filter wheel or the light source 15 has a plurality of light emitting diodes with different emission spectra. The selection of the respective required spectral range of the transmitted light can take place by means of a control and evaluation circuit 19 which is connected to the light source 15. The diffuser 17 can—as shown by way of example—be made as a planar surface or also as a diffuser sphere.

An optical receiving system 21, which is shown only by way of example as a converging lens, is arranged on the side of the motion picture film 11 disposed opposite the light source 15. An optical diaphragm 23 is furthermore arranged in the received beam path. The optical receiving system 21 images the picture section of the motion picture film 11 to be scanned onto an optoelectronic light receiver 25 which is made, for example, as a CCD or CMOS receiver. The light receiver 25 is connected to an input of the control and evaluation circuit 19.

The scanning of the motion picture film 11 takes place in that it is moved frame-wise along a transport direction 27 by means of a drive device (not shown). In every position of rest of the motion picture film 11, the picture section released by the film track 13 is illuminated sequentially by a corresponding control of the light source 15 by red, green, blue and infrared light, with a respective scanning recording simultaneously being generated by means of the light receiver 25 or being read out by means of the control and evaluation circuit 19.

To be able to optimize the imaging properties of the optical receiving system 21, the diaphragm 23 is divided into a plurality of regions, as will be explained in the following.

FIG. 2 shows the diaphragm 23 in a front view. The diaphragm 23 has a central region 29 which is transparent in the visible range and in the infrared range and which is surrounded by a ring-shaped filter region 31 which is in turn surrounded by a frame-shaped marginal region 33. The filter region 31 is made as a spectral filter, namely an infrared blocking filter. The marginal region 33 is impermeable for both visible light and infrared light and can in particular serve as a diaphragm mount or as a holder for the central region 29 and the filter region 31.

Due to the design of the filter region 31 as an infrared blocking filter, the diaphragm 23 effectively has two different diaphragm apertures for received visible light, on the one hand, and received infrared light, on the other hand, with a stronger beam limitation being effected for infrared light than for visible light. Aberrations of the optical receiving system 21 caused in particular in the marginal region of the optical receiving system 21 for infrared light can thereby be suppressed or the optical receiving system 21 can be optimized more easily with respect to the diaphragm aperture for the infrared spectral region reduced in the infrared range. A mechanical variability of the diaphragm aperture for visible light or for infrared light is not necessary due to the design of the diaphragm 23 with the filter region 31.

The reduced diaphragm aperture in the infrared spectral range admittedly also results in a reduced light performance, i.e. to a reduced intensity of the received infrared light acting on the light receiver 25. However, this can be easily compensated in the arrangement shown in FIG. 1, for example by an increased transmission power of the light source 15 for the infrared channel or by a correspondingly extended exposure time for the infrared scanning.

The description of the invention is merely exemplary in nature and, thus, variations that do not depart from the gist of the invention are intended to be within the scope of the invention. Such variations are not to be regarded as a departure from the spirit and scope of the invention.

1. A film scanner for the optical scanning of a film (11) in different spectral ranges, comprising:
an optical receiving system (21),
a diaphragm (23), and
an optoelectronic light receiver (25),
wherein the diaphragm (23) has a substantially transparent central region (29) and at least one filter region (31) which surrounds the central region and is made as a spectral filter.

2. A film scanner in accordance with claim 1,
wherein the filter region (31) has a different transmission capability in the visible spectral range and in the infrared spectral range.

3. A film scanner in accordance with claim 1, wherein the filter region (31) is substantially transparent in the visible spectral range and is substantially impermeable to light in the infrared spectral range.

4. A film scanner in accordance with claim 1, wherein the filter region (31) surrounds the central region (29) of the diaphragm (23) in ring shape.

5. A film scanner in accordance with claim 1, wherein the filter region (31) and the central region (29) are formed by a common plate which is provided with the spectral filter at the filter region.

6. A film scanner in accordance with claim 1, wherein the diaphragm (23) has a light impermeable marginal region (33) which surrounds the central region (29) and the filter region (31).

7. An optical diaphragm (23) comprising a substantially transparent central region (29) and at least one filter region (31) which surrounds the central region and is made as a spectral filter.
